(19) United States
(12) Patent Application Publication
(10) Pub. No.: US 2011/0003681 A1
(43) Pub. Date: Jan. 6, 2011

(54) REFORMING CATALYST FOR MOLTEN CARBONATE FUEL CELLS

(75) Inventors: Thomas Speyer, Schliersee (DE); Wolfgang Gabriel, Rosenheim (DE); Klaus Wanninger, Kolbermoor (DE); Uwe Wurtenberger, Munchen (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignees: SUD-CHEMIE AG, Munchen (DE); MTU ONSITE ENERGY GMBH, Friedrichshafen (DE)

(21) Appl. No.: 12/528,511

(22) PCT Filed: Feb. 26, 2008
(86) PCT No.: PCT/EP2008/052305

§ 371 Date: Sep. 21, 2010

(30) Foreign Application Priority Data
Feb. 27, 2007 (DE) 10 2007 009 556.4

(51) Int. Cl. B01J 23/755; B01J 21/06; B01J 31/06; B01J 31/02; B01J 35/12; B01J 21/04

(52) U.S. Cl. 502/159; 502/337; 502/259; 502/150; 502/100; 502/355; 502/349; 502/335; 977/773

(57) ABSTRACT

The present invention relates to a catalyst composition and a catalyst material which are suitable for use as a reforming catalyst in a fuel cell and are less susceptible to catalyst poisoning by alkali metals. The invention also relates to a catalyst suspension for the preparation of the catalyst composition and the catalyst material, plus a process for the preparation of the catalyst suspension and the catalyst composition. The invention is also directed towards the use of the catalyst composition or the catalyst material in a fuel cell.

The present invention relates to a catalyst composition and a catalyst material which are suitable for use as a reforming catalyst in a fuel cell and are less susceptible to catalyst poisoning by alkali metals. The invention also relates to a catalyst suspension for the preparation of the catalyst composition and the catalyst material, as well as to a process for the preparation of the catalyst suspension and the catalyst composition.

### STATE OF THE ART

In molten carbonate fuel cells (MCFCs), electricity is generated via electrochemical reactions between cathode and anode and an electrolyte matrix lying between them. The electrolyte matrix is normally a molten eutectic mixture of Li₂CO₃ and K₂CO₃. The eutectic mixture melts above 490° C.

Electrochemical reactions are strongly exothermic. One problem therefore is the elimination of heat in the fuel cell. Since a high temperature is necessary for operation in the fuel cell, a steam reforming reaction can be carried out directly in the cell. A methane steam reforming reaction may be mentioned by way of example:

CH₄⁺H₂O→CO+3H₂ ΔH=+49.2 kcal/mol (1)

CO+H₂O→CO₂+H₂ ΔH=−9.8 kcal/mol (2)

The first reaction is strongly endothermic and can directly consume the heat being released from the electrochemical reaction. This reaction is a catalytic reaction which requires a reforming catalyst (e.g. an Ni catalyst), wherein it is possible to use natural gas (optionally also methane, petroleum gas, naphtha, heavy oil or crude oil) as the starting material for operating the fuel cell. The basic information on methane steam reforming is contained in numerous works in the literature (see e.g. “Catalytic Steam Reforming” in “Catalysis” Science and Technology, Vol. 5, Springer Verlag, Berlin, 1985 or “Catalysis” Vol. 3, Specialist Periodical Reports, London 1980, The Chemical Society). Commercial nickel catalysts for methane steam reforming are described for example in Catalysis Science and Technology, J. R. Andersen and M. Boudart, Vol. 5, Springer-Verlag, Berlin 1984.

Today, part of the reforming is usually carried out in a pre-reformer. This is advantageous, as hydrogen should already be available at the entrance to the cell. However, another part of the reforming is to take place in the cell. It is advantageous if the endothermic reforming takes place in the most direct possible proximity to the electrochemical reaction, firstly because of the favoured heat exchange, secondly because of the shift of the chemical equilibrium. Steam reforming is an equilibrium reaction, i.e. the higher the temperature is, the more the equilibrium lies on the side of the hydrogen. The equilibrium can also be shifted by constantly consuming the hydrogen in the electrochemical reaction. Only in this way can almost complete methane conversions be achieved. A direct coupling of the electrochemical reaction with the reforming in the anode half-cell is therefore advantageous.

Such a system of an anode half cell with a catalyst is described in US 2002/0197518 A1, wherein a highly active steam reforming catalyst is needed.

A problem occurring in this case is described in DE 10156033. KOH which diffuses through the gas phase and poisons the catalyst is formed from the electrolyte Li₂CO₃/K₂CO₃ in the equilibrium at the high operating temperature. Potassium is a strong poison for nickel catalysts. As a solution to the problem, DE 10165033 proposes the use of a potassium adsorption material on a carrier (e.g. paper) between anode and catalyst. On the one hand, the adsorption material can be rapidly saturated, on the other hand the quantity of potassium is irreversibly removed from the electrolyte and there is a shift in the equilibrium towards fresh KOH formation. In addition an effective K adsorption can be guaranteed only with a very fine-pored layer which displays a high pressure drop or a small gas exchange between the layer with catalyst and the porous current-collector layer.

US 2001/026881 A1 describes an Ni membrane for intercepting KOH in order to prevent catalyst poisoning. However, the diffusion problem as described in DE 10165033 also occurs here.

Furthermore, in the current state of the art, Ni catalysts in the form of pellets and extrudates are used on the anode side. However, the charging of large cell surface areas with catalyst, in order that a free flow and a low pressure drop remain guaranteed, is difficult and expensive. In WO 02/052665 A1 and DE 10165033 A1, therefore, a coating of the catalyst on a nickel surface or on the porous current collectors is described. However, there is often a problem with the adhesion of the catalyst to the surface in this case. Catalyst particles that become detached could block channels and damage the system.

The object of the present invention is therefore to provide a system which effectively prevents catalyst poisoning by KOH and does not have the above-named problems. A catalyst which has a greater resistance to potassium and good adhesion to surfaces would also be advantageous.

This object is achieved by a catalyst composition for methane steam reforming which comprises an Ni catalyst and a binding agent, and is characterized in that the catalyst has a pore volume of at least 200 mm³/g.

The catalyst composition according to the invention with high pore volume surprisingly has a lower sensitivity to poisoning by KOH than catalysts from the state of the art with lower pore volumes.

According to a preferred embodiment, the pore volume is 300 mm³/g to 1500 mm³/g, in particular between 400 and 1000 mm³/g. Particularly preferably, the pore volume lies between 700 and 800 mm³/g. The pore volume is determined using the mercury intrusion method based on DIN 66133, as described in detail below. In particular, the pore volume is the specific total pore volume (relative to pores with radii of 3.7-7500 nm). The pore radius can be determined applying the Washburn equation, as indicated in DIN 66133.

The catalyst for the catalyst composition preferably contains nickel, silicon and aluminium. Further details of the catalysts and binding agents which can be used according to the invention are given within the framework of the discussion of the preparation process.

Furthermore, it is preferred if the catalyst comprises particles having a particle size with a d₅₀ value of 2 to 10 μm, in particular with a d₅₀<5 μm. Particularly preferably, the particle size has a d₅₀ value=3 μm. The particle size should not exceed 20 μm. The d₅₀ value means that 50% of the particles have this value (particle diameter). The particle sizes are determined by laser scattering measurements, as described below.

A subject of the invention is furthermore a process for the preparation of a catalyst suspension for methane steam reforming, wherein the process comprises the following step:
preparing a suspension comprising a binding agent and an Ni catalyst powder in a dispersant,
   characterized in that a burnout material is furthermore added to the suspension.

It was surprisingly found that a catalyst composition prepared according to this process which is characterized by a higher pore volume than catalysts according to the state of the art has a lower sensitivity to poisoning by KOH. By adding a binding agent, preferably a sol, to improve adhesion within the framework of the process according to the invention, the pores of the catalyst can be blocked. This negative effect can, however, be corrected by adding a burnout material. As a result, the catalysts which are prepared according to the process according to the invention have a very good adhesion and low sensitivity to poisoning by KOH.

Catalysts which are customary in the trade can be used as the catalyst. Highly active Ni catalysts, in particular precipitated catalysts, are particularly suitable. The catalyst can be doped with Mg in order to achieve a greater resistance to the formation of soot. This is advantageous for example if higher hydrocarbons are reformed. These higher hydrocarbons are converted in the entire system of the fuel cell in a pre-reformer. Therefore Mg-free precipitated Ni catalysts are also used for the internal reforming.

The catalyst used is preferably a hydrogenating catalyst, particularly preferably the catalyst is an Ni hydrogenating catalyst. An example of a hydrogenating catalyst which is customary in the trade is the C-46-8® catalyst from Süd-Chemie AG (BET surface area=170-200 m²/g, Ni: 42.7 wt.-%, Al 14.1 wt.-%, Si 1-10 wt.-%). By way of example, the C11-PR® catalyst from Süd-Chemie AG can be named as an example of a so-called pre-reformer catalyst which is used in hydrogen plants for the early reaction of higher hydrocarbons. In particular, generally available supported Ni catalysts which are applied to usual carrier materials, such as aluminium oxide, silica, etc., are suitable.

The catalyst which is customarily used in the form of a powder is ground to a uniform particle size, wherein this generally has a d₅₀ value of 2-10 μm, preferably a d₅₀ value of approximately 5 μm. It is furthermore preferred that the particle size of the catalyst does not exceed 20 μm.

The catalyst can be ground in any known mill, for example a beater mill, and the particles with the desired particle size can be separated by a cyclone. Other methods for separating the correspondingly large catalyst particles are also conceivable, for example centrifugation or sedimentation.

A suspension is prepared in a dispersing medium from the ground catalyst (catalyst powder) and the binding agent. The organic and not-organic solvents known in the art are suitable as the dispersing medium. Preferably, the dispersing medium is water. In addition, for example alcohols such as methanol, ethanol, propanol, isopropanol, polyhydric alcohols such as glycol, polyalcohols, polyether glycols or acetone can be used as the dispersing medium. Mixtures of the above-named dispersing mediums can likewise be used. Dispersant auxiliaries and additives and dispersants known from the state of the art can optionally be added to these. The catalyst powder can be added at the same time as, before or after the binding agent. The Ni catalyst is preferably added after the addition of the binding agent to the dispersing medium.

The suspension obtained is then preferably wet-ground, preferably to a particle size of d₅₀<5 μm, particularly preferably to a particle size of d₅₀=3 μm. The wet grinding can take place in a bead mill, for example in a bead mill with zirconium oxide beads. The suspension is to be kept at a pH<7, preferably at a pH of 5-7 and particularly preferably at a pH of 6-6.5, using acetic acid. The suspension which is wet-ground can be a suspension which contains both the catalyst powder and the binding agent or one which contains only the catalyst powder or only the binding agent.

Within the framework of the present invention, a binding agent is added to the suspension. An improvement in the adhesion of the catalyst coating which is applied as a suspension, in particular as an aqueous suspension (washcoat), is thereby achieved. The binding agent can be added before or after the above-described wet grinding. The binding agent is preferably a sol, particularly preferably a sol comprising Al₂O₃ nanoparticles (for example Disperal® from Sasol) or ZrO₂ nanoparticles (for example Zr acetate from MEL Chemicals, NYACOL® products). Also preferred are cerium oxide sols (e.g. from NYACOL), silicon dioxide sols (e.g. Kostrosol®) and titanium dioxide sols (e.g. from Sachleben-Chemie). Most preferably, a zirconium sol is used. By sols are meant homogeneous clear solutions which contain nanoparticles of the order of magnitude of approximately 2-50 nm. Commercially available sols are usually acetate-stabilized sols or nitrate-stabilized sols (nitric acid).

According to the invention, a burnout material is added to this suspension. The burnout material can be added before, after or at the same time as the addition of the binding agent and the Ni catalyst. The burnout material is preferably added to a suspension comprising binding agent and Ni catalyst powder in the dispersing medium. The burnout material is organic combustible material. The burnout material is also preferably an organic polymer. The preferred materials include hydrocarbon compounds, in particular oxygen-containing hydrocarbon compounds which are present in finely ground form. Most preferably, the burnout material is present in powder form. Preferred burnout materials include for example finely ground cellulose, paraformaldehyde, polyoxymethylene or end-group functionalized derivatives thereof; polyethylene, etc. Particularly preferably, cellulose is used. It is desirable that the burnout material burns out completely and residue-free in air up to 350° C. The burnout material is preferably a high-molecular organic material which can be burnt out almost residue-free, preferably at temperatures above 100° C., particularly preferably at temperatures between 150 and 450° C. and still more preferably at temperatures between 200 and 400° C. In particular, the burnout materials do not include low-molecular compounds such as ammonium carbonate or bicarbonate, urea, formamide, dimethyl formamide, acetamide, dimethyl acetamide or hexamethylenetetramine.

The clogging of the pore entrances of the porous catalyst material by nanoparticles of the binding agent can be dealt with by adding the burnout material. Surprisingly it was shown that catalysts according to the invention firstly have a good adhesion due to the presence of the binding agent and secondly display an increased resistance to poisoning by potassium, which is shown by a lower loss of activity when potassium is present. The catalysts according to the invention which have a higher pore volume than catalysts which were prepared without the addition of a burnout material surprisingly show a lower susceptibility to poisoning by KOH.

The burnout material can be added to the suspension in a quantity in the range of 1-30 wt.-%, preferably 5-15 wt.-% and particularly preferably 10 wt.-%, relative to the dry weight of the suspension.

According to the above-described process, a catalyst suspension according to the invention for methane steam reforming is thus obtained which comprises a binding agent and is characterized in that the suspension additionally contains a burnout material. The catalyst suspension preferably contains the burnout material in a quantity in the range of 1-30 wt.-%, preferably 5-15 wt.-% and particularly preferably 10 wt.-%, relative to the dry weight of the suspension. The burnout material contained in the catalyst suspension is preferably an organic material, preferably cellulose. The binding agent is a sol, preferably a sol comprising Al₂O₃ or ZrO₂ nanoparticles.

The catalyst suspension obtained in this way can be used to prepare a catalyst composition with a high catalyst pore volume, as described above.

A subject of the invention is also a process for the preparation of a catalyst composition, wherein the process comprises the heating of the catalyst suspension represented above in order to burn out the burnout material. The heating comprises both drying and calcining. The calcining normally takes place at 250-450° C., preferably at 300-400° C.

In particular, the invention comprises a process for the preparation of a catalyst composition for methane steam reforming the steps of
1. preparing a suspension comprising a binding agent and an Ni catalyst powder in a dispersing medium,
2. adding a burnout material to the suspension, and
3. then heating the mixture.

The suspension can be prepared by mixing, in particular stirring or grinding. The catalyst powder can be introduced at the same time as, before or after the binding agent. The catalyst is preferably added after the addition of the binding agent to the suspension. The burnout material can be added at the same time as or after the addition of the catalyst and the binding agent. The burnout material is preferably added to a suspension comprising binding agent and catalyst. It is also preferred if the suspension comprising catalyst and binding agent is wet-ground before the burnout material is added.

For the preparation of the catalyst composition, the catalyst suspension is preferably coated onto a carrier before the burning out. The carrier can have a metal surface. However, as described in WO 02/052665 A1, the catalyst suspension is preferably applied to a carrier which is a porous material, such as e.g. a porous foam. Particularly preferably, the porous foam is a metal foam and most preferably an Ni foam. After the carrier has been coated, the suspension is dried and/or optionally calcined.

Calcining is not essential, since the burnout material burns out anyway at the high operating temperatures in the fuel cell. This corresponds to an in situ calcining.

With regard to further preferred embodiments in connection with preferred materials (Ni catalyst powder, binding agent, burnout material, dispersing medium) and preferred process steps, reference is further made to the above statements concerning the catalyst compositions according to the invention and the preparation of a catalyst suspension.

Another subject of the invention is a catalyst composition which can be obtained according to a process comprising the steps of
1. preparing a suspension comprising a binding agent and an Ni catalyst powder in a dispersing medium,
2. adding a burnout material to the suspension, and
3. then heating the mixture.

With regard to preferred embodiments, reference is made to the above description in connection with the corresponding preparation process. The catalyst composition obtained is further characterized in that it preferably has a pore volume of 300 mm³/g to 1500 mm³/g and comprises particles having a particle size with a d₅₀ value of 2 to 10 μm. As already discussed above, catalyst compositions according to the invention which contain an Ni catalyst and a binding agent and can be obtained according to the process described here are characterized by a lower susceptibility to poisoning by potassium.

Another subject of the invention is a catalyst material which comprises a catalyst composition coated onto a carrier, as described above.

The catalyst material or the catalyst composition is particularly suitable for use as a catalyst and in particular for use as a reforming catalyst in a fuel cell.

A fuel cell which contains the catalyst materials or catalyst compositions according to the invention is also part of the invention.

As already stated above, the catalyst compositions according to the invention with a high pore volume have a lower susceptibility to poisoning by KOH than catalysts known from the state of the art.

The present invention is described in more detail below using examples. In the examples, reference is also made to the attached figures. There are shown in:

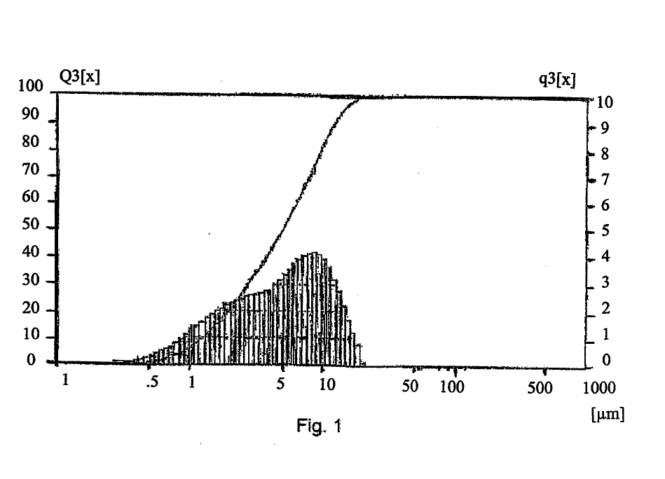

FIG. 1 the particle-size distribution of a hydrogenating catalyst after dry grinding,

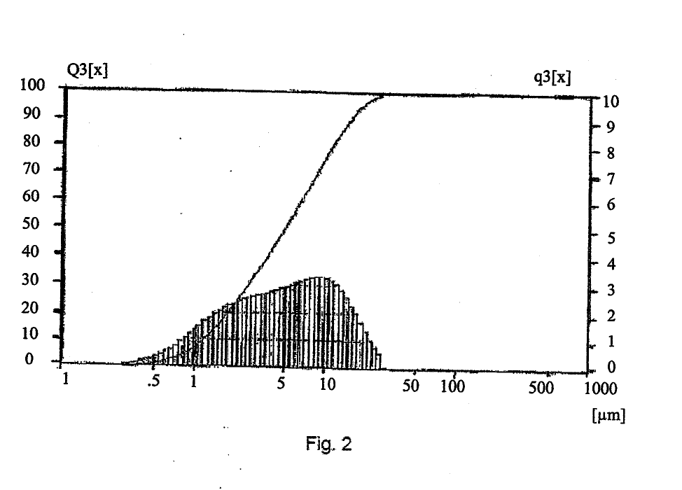

FIG. 2 the particle-size distribution of a hydrogenating catalyst after a second dry grinding,

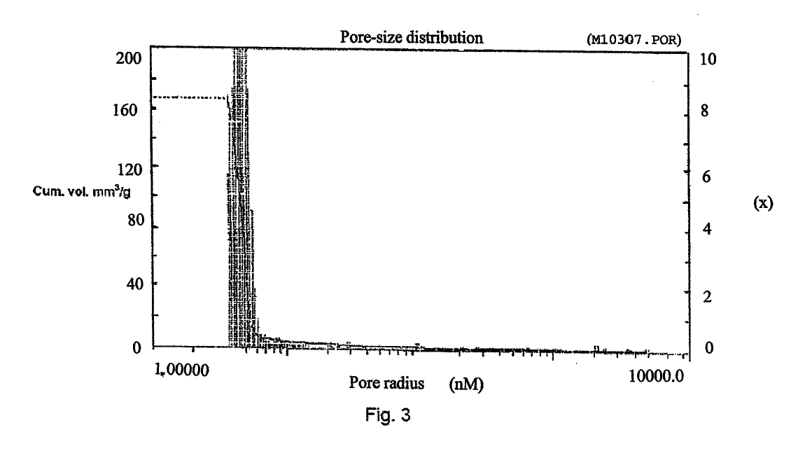

FIG. 3 the pore-size distribution and the pore volume of a catalyst, obtained from a catalyst suspension without additional burnout material (Example 1),

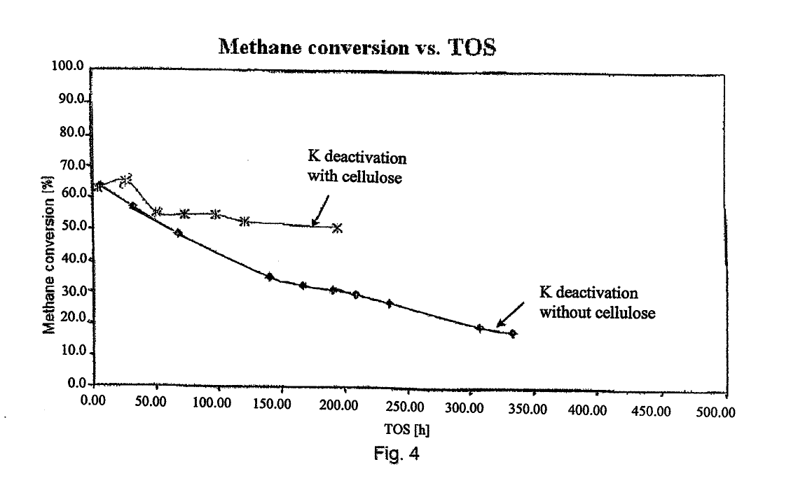

FIG. 4 the activity and deactivation of catalysts, obtained from a catalyst suspension with and without additional burnout material, and

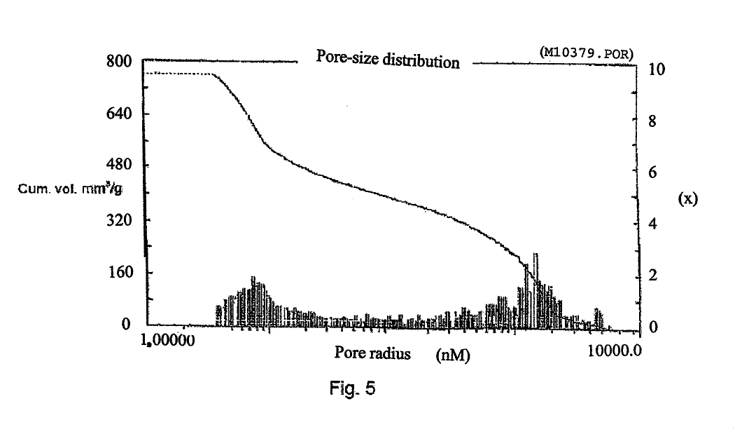

FIG. 5 the pore-size distribution and the pore volume of a catalyst of a catalyst composition according to the invention (Example 2).

### GENERAL PROCEDURES AND ANALYSIS

Unless otherwise indicated, standard methods from chemistry and chemical process engineering were used.

The pore volume was determined according to DIN 66133. In particular, a mercury porosimetry was carried out with a mercury porosimeter of the Carlo Erba Porosimeter 4000 type. The capillary radius was 1.5 mm and the mercury volume 15 ml. The pressure range was 1-2000 bar.

The particle size and the particle-size distribution of the catalyst were determined by laser scattering with a FRITSCH PARTICLE SIZER ANALYSETTE 22 with a measurement range of 0.1-501 μm. The evaluation took place according to the Fraunhofer method. The sample chamber is filled with circulated water which is stirred at 50 revolutions/min. and pumped through the cell at 100 revolutions/min. In addition, Ultrasound is used in order to maintain the dispersion.

The BET surface area was determined according to DIN 66131. The evaluation is done according to the multipoint method with 5 measurement points. The drying took place at 150° C. immediately before the measurement. The pressure range p/p₀=0.05-0.27 was measured.

### Preparation of a Catalyst Powder

A Süd-Chemie AG Ni hydrogenating catalyst C-46-8® which is customary in the trade (BET surface area=170-200 m²/g; Ni=42.7 wt.-%; Al=14.1 wt.-%; Si=1-10 wt.-%) was ground in a beater mill (Netsch type CUM 100 with a turbine rotor and 200-μm screen). The particle-size distributions after the first and second dry grindings are shown in FIG. 1 and FIG. 2 respectively.

This C-46-8® powder served as the starting material for the further experiments.

### Example 1

### Comparison Example

18 kg of the above-described catalyst powder was gradually stirred slowly into a mixture of 27 kg water and acetic acid of pH 6, the pH was checked constantly and kept between 6 and 6.4.

This suspension was ground in a bead mill. The mill used was a WA Bachofen Dyno-Mill with 250 ml grinding capacity. 200 ml Y-stabilized zirconium oxide beads from Joti with a diameter of 1-1.2 mm were used. 59.55 g isopropanol and 7.95 g Agitan 290® (defoamer) and 209.55 g zirconium sol (MEL Chemicals 20% Zr) were stirred into 600 g of this suspension as binding agents.

This suspension was coated onto a 3-mm-thick Ni foam sheet and the coating was dried, with the result that a 25-mg/cm²-thick coating was on the foam.

The reforming activity and the deactivation by potassium hydroxide vapour of the coated Ni foam sheet were tested according to the process described below.

Three of the coated porous Ni sheets were stacked with a thin Ni plate between them and placed, in a special sample holder, in a reactor having three heating zones. The sample was fitted between the 2^{nd} and 3^{rd} heating zones. A cage suspended in the closed reactor in the middle of the 1^{st} heating zone was attached to the upper flange of the reactor via a rod. This cage was filled with 3-mm beads of α-Al₂O₃ which were impregnated with 6.3% K₂CO₃ and dried. At the start of the experiment, testing was carried out for 2 days without these beads. The reactor was then cooled down, opened under a nitrogen stream and the test was continued after the introduction of the K₂CO₃-impregnated aluminium oxide beads.

The precise test procedure is described below:

At the start of the test, the above-described coated porous Ni sheets were heated in the reactor for 3 h under air at 400° C. The burnout material thus burned out of the catalyst. There followed reduction for approx. 15 h (over night) at 650° C. with hydrogen. This was followed by reforming for 3 h at 650° C. with the following gas mixture (% by volume): 31% CO, 30% CH₄, 33% CO₂, 6% H₂. The space velocity was 50,000/h; it was chosen so as to remain below thermodynamic conversion even at the outset. After 3 h the mixture was measured and was heated over night to 750° C. for faster deactivation. On the next day, the temperature was lowered again and the mixture measured after waiting 3 h. Then it was cooled as described above, the potassium source was incorporated and it was tested again and the procedure was repeated alternately for 3 h at 650° C. and for 21 h at 750° C.

At weekends (long periods of time between the measurement points), the temperature remained at 750° C. for two days.

The results of the activity measurements are shown in FIG. 4. TOS (time-on-stream) stands for the total operating time, wherein the first two measurement points were measured without potassium source. FIG. 4 shows that the methane conversion rate, i.e. the activity of the catalyst, falls rapidly when a potassium source is present, due to poisoning of the catalyst which did not contain a cellulose fuel.

Some of the catalyst suspension was poured into a dish, dried and calcined at 440° C. (burning out of the organic contents). The product was then granulated to 2-3 mm and the pore volume determined by means of mercury porosimetry, as described above. The pore volume of this catalyst was 169 mm³/g. The pore distribution is shown in FIG. 3. It will be seen that 96% of the pores are smaller than 7 nm.

### Example 2

940 g of the above-described catalyst powder was stirred into a mixture of 1420 g water, 58 g acetic acid, 196 g isopropanol and 48 g Agitan 290® (defoamer) and (22% MEL Chemicals) 3498 g zirconium sol. The suspension was ground as described in Example 1. 130 g cellulose (Mikro-Technik GmbH type 402 KS®) was stirred into 1300 g of this suspension.

This catalyst suspension was coated onto Ni foam sheets, as described in Example 1, and some of the catalyst suspension was dried and calcined, as described in Example 1.

Analogously to Example 1, the pore volume was measured for the catalyst according to the invention. This was 762 mm³/g and was therefore clearly larger than that of the catalyst from Example 1. The pore-size distribution of the catalyst according to the invention according to Example 2 is shown in FIG. 5.

The measurement of the activity and potassium deactivation of the catalyst according to the invention was carried out analogously to Example 1. The measurement of the activity and deactivation under KOH vapour is shown in FIG. 4. It can clearly be seen that after the second measurement point, i.e. after the addition of potassium, a loss of activity is also to be observed for the catalyst according to the invention. However, the subsequent loss of activity as time passes is clearly lower than for the catalyst according to Example 1 with the low pore volume.

1. Catalyst composition for methane steam reforming, comprising an Ni catalyst and a binding agent, characterized in that the catalyst has a pore volume of at least 200 mm³/g.

2. Catalyst composition according to claim 1, wherein the pore volume lies between 700 and 800 mm³/g.

3. Catalyst composition according to claim 1, wherein the catalyst comprises particles having a particle size with a d₅₀ value of 2 to 10 μm.

4. Catalyst composition according to claim 3, wherein the d₅₀ value lies between 2 and 5 μm.

5. Catalyst composition according to claim 1, wherein the catalyst comprises nickel, silicon and aluminium.

6. Process for the preparation of the catalyst composition for methane steam reforming claim 1, comprising the steps of
preparing a suspension comprising a binding agent and an Ni catalyst powder in a dispersing medium,
adding a burnout material to the suspension, and
then heating the mixture to produce the catalyst composition.

7. Process according to claim 6, wherein an organic polymer, preferably cellulose, comprises the binding agent and a sol comprises the burnout material.

8. Process according to claim 6, wherein the process further comprises applying the suspension to a carrier prior to the heating step.

9. Process according to claim 6, wherein the heating comprises drying and/or calcining, preferably at 300-400° C.

10. (canceled)

11. (canceled)

12. Process according to claim 6, wherein the dispersing medium comprises water.

13. Process according to claim 6, wherein the suspension is wet-ground before or after the addition of the binding agent.

14. Process according to claim 6, wherein the burnout material is added before, after or at the same time as the addition of the binding agent.

15. Process according to claim 6, wherein the burnout material comprises an organic material, preferably cellulose.

16. Process according to claim 6, wherein 1-30 wt.-%, of burnout material, relative to the dry weight of the suspension, is added.

17. Process according to claim 6, wherein the catalyst composition comprises particles having a particle size with a d₅₀ value of 2 to 10 μm.

18. Process according to claim 6, characterized in that the suspension is kept at a pH<7.

19. Process according to claim 6, wherein the binding agent comprises a sol, preferably a sol comprising Al₂O₃ or ZrO₂ nanoparticles.

20. Catalyst suspension, comprising a catalyst for methane steam reforming and a binding agent, characterized in that the suspension additionally contains a burnout material.

21. Catalyst suspension according to claim 20, wherein the suspension contains 1-30 wt.-%, burnout material, relative to the dry weight of the suspension.

22. Catalyst suspension according to claim 20, wherein the burnout material comprises an organic material, preferably cellulose.

23. Catalyst suspension according to claim 20, characterized in that the binding agent comprises a sol, preferably a sol comprising Al₂O₃ or ZrO₂ nanoparticles.

24. (canceled)

25. Process of claim 6 further comprising burning out the burnout material.

26. (canceled)

27. Process according to claim 25, wherein the calcining is carried out at 250-450° C.

28. Process according to claim 25, wherein the catalyst suspension is coated onto a carrier before the burning out.

29. Process according to claim 28, wherein the carrier comprises porous material, preferably an Ni foam.

30. Process according to claim 28, wherein the carrier has a metal surface.

31. (canceled)

32. (canceled)

33. (canceled)

34. (canceled)
